(19) United States
(12) Patent Application Publication
(10) Pub. No.: US 2019/0225367 A1
(43) Pub. Date: Jul. 25, 2019

(54) BOTTLE CARRYING AND OPENING SYSTEM AND METHOD

(71) Applicant: Harnek Dosanjh, Surrey (CA)

(72) Inventor: Harnek Dosanjh, Surrey (CA)

(21) Appl. No.: 15/877,257

(22) Filed: Jan. 22, 2018

(51) Int. Cl. B65D 5/42; B67B 7/16

(52) U.S. Cl. CPC B65D 5/4208; B65D 77/30; B67B 7/16

(57) ABSTRACT

A bottle carrying and opening system includes a container and a bottle opener. The container includes a bottom wall and a perimeter wall extending upwardly from the bottom wall. The container further includes an interior space configured to hold bottles inside it. The bottle opener is coupled to the perimeter wall of the container and is configured to remove a cap of a bottle. The bottle opener includes a base panel and a functional sports article, wherein the functional sports article is shaped to represent a hockey puck, baseball, football, or basketball. The bottle carrying and opening system is useful for carrying bottles for opening bottles using the built-in bottle opener, which is always conveniently on hand, cannot be misplaced, and has an appealing look inspired by a current sports season.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of bottle cases of existing art and more specifically relates to bottle cases with bottle openers.

### RELATED ART

Watching a sports game is one of a sports fan's favorite pastimes. The enjoyable experience is commonly enhanced by consumption of food and drink, such as beer. Beer or another beverage may be purchased as a case containing bottles. The beverage is typically contained in a bottle with a cap, and the cap must be removed before the beverage can be consumed. A bottle cap is typically removed by using a bottle opener, typically a small, easily displaced device. A bottle opener may be kept in a kitchen drawer, among other utensils and tools. A person may need to rummage through the drawer in search of the bottle opener. Further, when there is a group of sports fans watching a sports game together, the bottle opener may be moved around as those present take turns in using it to open new bottles. Sports fans desire to have their eyes on the screen, keenly following the game. It is desirable to eliminate all distractions, such as a search for a bottle opener. A convenient way for making a bottle opener available for everybody present at the game-viewing gathering is desired.

Sports fans also like to use and wear items with sports-inspired designs, such as beer glasses, cups, T-shirts, and caps. The designs may be inspired by a particular sport. There is an ever-growing need for a variety of items bearing such designs. It is desirable to make novel products that allow expression of a sports fan's enthusiasm for a sport.

U.S. Pat. No. 2,875,654 to Watson A. Straub relates to a combined bottle carrying case and bottle cap remover. The described combined bottle carrying case and bottle cap remover includes a bottle opener of the crown cap removing type of such form that it can be applied in unitary relation with a case that contains beverage bottles, so as to always be present when the user receives a case of beverages.

### SUMMARY OF THE INVENTION

In view of the foregoing disadvantages inherent in the known bottle cases art, the present disclosure provides a novel bottle carrying and opening system. The general purpose of the present disclosure, which will be described subsequently in greater detail, is to provide a case for carrying bottles having a built-in bottle opener that is always conveniently on hand and cannot be misplaced, and has the appealing look inspired by a current sports season.

A bottle carrying and opening system is disclosed herein. The bottle carrying and opening system includes a container and a bottle opener. The container includes a bottom wall and a perimeter wall extending upwardly from the bottom wall. The container further includes an interior space configured to hold bottles inside. The bottle opener is vertically and externally coupled to the perimeter wall of the container and is configured to remove a cap of a bottle. The bottle opener includes a base panel and a functional sports article, wherein the base panel is coupled to the perimeter wall of the container (only not the top or bottom) and the functional sports article is coupled to the base panel. The functional sports article is shaped to represent a hockey puck, baseball, football, or basketball.

According to another embodiment, a method of carrying and opening bottles is also disclosed herein. The method of carrying and opening bottles includes a first step, providing a bottle carrying and opening system including a container and a bottle opener (as described above), a second step, removing a bottle from the container, and a third step, removing a cap of the bottle using the bottle opener.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a bottle carrying and opening system, constructed and operative according to the teachings of the present disclosure.

FIG. 1 is a side perspective view of the bottle carrying and opening system during an ‘in-use’ condition, according to an embodiment of the disclosure.

FIG. 2 is a side perspective view of the bottle opener which is part of the bottle carrying and opening system of FIG. 1, according to an embodiment of the present disclosure.

FIG. 3 is a side perspective view of the bottle opener which is part of the bottle carrying and opening system of FIG. 1, according to another embodiment of the present disclosure.

FIG. 4 is a side perspective view of the bottle opener which is part of the bottle carrying and opening system of FIG. 1, according to another embodiment of the present disclosure.

FIG. 5 is a flow diagram illustrating a method for carrying and opening bottles, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to bottle cases with bottle openers and more particularly to a bottle carrying and opening system as used to improve the carrying and opening of drink bottles.

Generally, the bottle carrying and opening system allows a consumer who enjoys watching sports games to carry and keep drink bottles in a single container. The system further allows the consumer to open the bottles using a bottle opener built into the container. The built-in bottle opener is always conveniently on hand, cannot be misplaced, and has the functional and appealing look inspired by a current sports season. The shape of the bottle opener may be shaped to represent a hockey puck, baseball, football, or basketball, depending on which of the four sports is in season and followed by the consumer. The bottle opener is (only) vertically mounted such that it can be easily accessed, manufactured at a reasonable price and such that it provides functional and aesthetic means for promoting sales of the product.

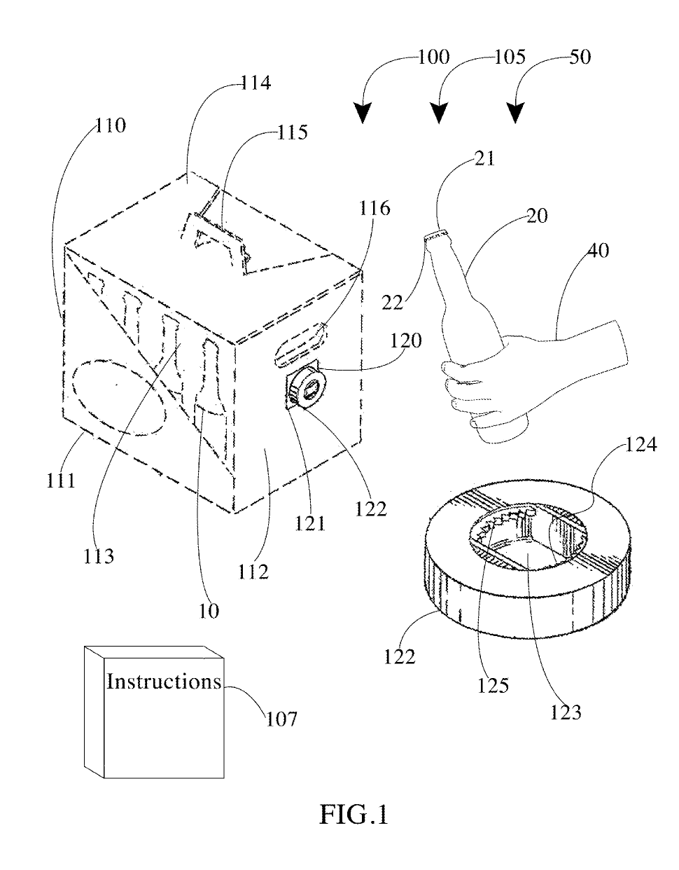

Referring now more specifically to the drawings by numerals of reference, there is shown in FIGS. 1-4, various views of a bottle carrying and opening system 100.

FIG. 1 shows a bottle carrying and opening system 100 during an ‘in-use’ condition 50, according to an embodiment of the present disclosure. Here, the bottle carrying and opening system 100 may be beneficial for use by a user 40 to carry and open drink bottles. As illustrated, the bottle carrying and opening system 100 may include a container 110 and a bottle opener 120. The container 110 may include a bottom wall 111 and a perimeter wall 112 extending upwardly from the bottom wall 111. The container 110 may further include an interior space 113 configured to hold bottles 10 inside it. The bottle opener 120 may be coupled to the perimeter wall 112 of the container 110 and may be configured to remove a cap 21 of a bottle 20.

The bottle opener 120 may include a base panel 121 and a functional sports article 122. The base panel 121 may be coupled to the perimeter wall 112 and the functional sports article 122 may be coupled to the base panel 121. Further, the base panel 121 may be adhesively coupled to the perimeter wall 112 and the functional sports article 122 may be adhesively coupled to the base panel 121. According to one embodiment, the base panel 121 and the functional sports article 122 may be made of plastic. Alternatively, the base panel 121 and the functional sports article 122 may be made of metal. The container 110 may be made of fiber board. Plastic components of the bottle carrying and opening system 100 may be formed with the use of plastic molding techniques such as injection molding or blow molding.

As illustrated, the functional sports article 122 may be shaped to represent a hockey puck and may include a hole 123 in its center configured to receive a lip 22 of the cap 21 of the bottle 20. The hole 123 in the center of the hockey puck may include a serrated bottom edge 124 and a serrated top edge 125. The bottle 20 may be opened by hooking the lip 22 of the cap 21 on the serrated bottom edge 124 or the serrated top edge 125, and pulling the bottle 20 towards the hole 123 in the center of the functional sports article 122.

In one embodiment, the perimeter wall 112 of the container 110 may include two opposing slits 116 configured to receive four human fingers each (not shown). The bottle opener 120 may be coupled to the perimeter wall 112 beneath one of the two slits 116. Further, the container 110 may include a top wall 114 removably coupled to the perimeter wall 112, and a handle 115 coupled to the top wall 114.

According to one embodiment, the bottle carrying and opening system 100 may be arranged as a kit 105. In particular, the bottle carrying and opening system 100 may further include a set of instructions 107. The instructions 107 may detail functional relationships in relation to the structure of the bottle carrying and opening system 100 such that the bottle carrying and opening system 100 can be used, maintained, or the like, in a preferred manner.

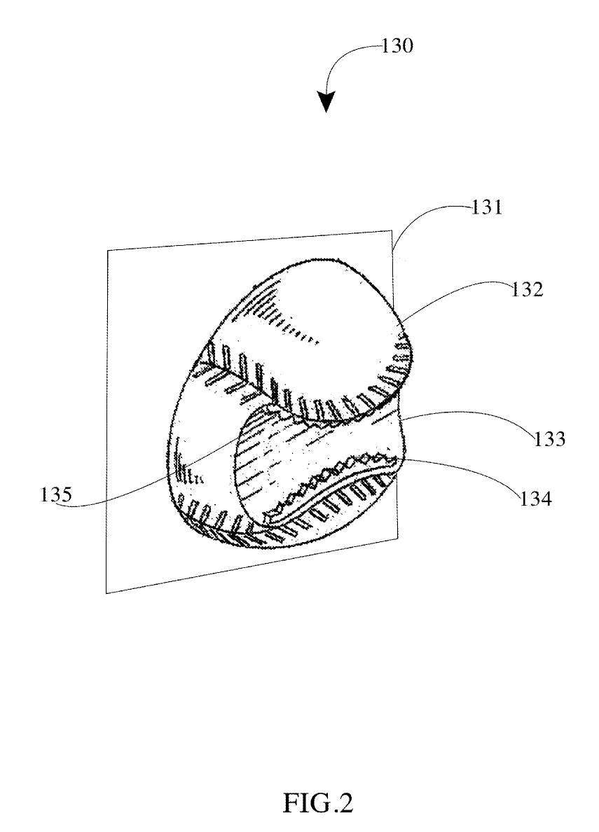

FIG. 2 shows the bottle opener 130 which is part of the bottle carrying and opening system 100 of FIG. 1, according to an embodiment of the present disclosure. The bottle opener 130 may include a base panel 131 and a functional sports article 132. The base panel 131 may be coupled to the perimeter wall 112 of the container 110, and the functional sports article 132 may be coupled to the base panel 131. The functional sports article 132 may be shaped to represent a baseball and may include a mouth opening 133 configured to receive the lip 22 (FIG. 1) of the cap 21 (FIG. 1) of the bottle 20 (FIG. 1). The mouth opening 133 may include a serrated bottom edge 134 and a serrated top edge 135. The bottle 20 may be opened by hooking the lip 22 (FIG. 1) of the cap 21 (FIG. 1) on the serrated bottom edge 134 or the serrated top edge 135, and pulling the bottle 20 (FIG. 1) towards the mouth opening 133.

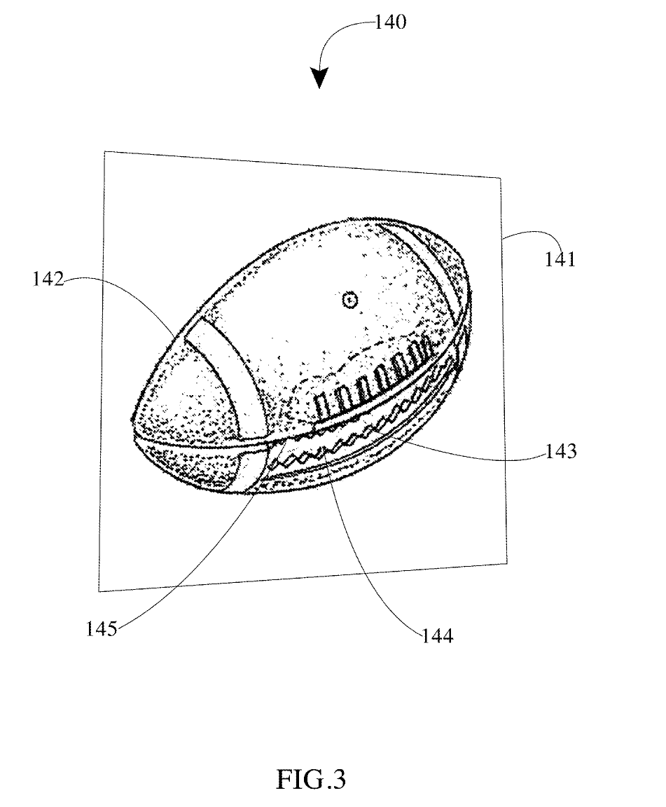

FIG. 3 shows the bottle opener 140 which is part of the bottle carrying and opening system 100 of FIG. 1, according to an embodiment of the present disclosure. As above, the bottle opener 140 may include a base panel 141 and a functional sports article 142. The functional sports article 142 may be shaped to represent a football and may include a mouth opening 143 configured to receive the lip 22 (FIG. 1) of the cap 21 (FIG. 1) of the bottle 20 (FIG. 1). The mouth opening 143 may include a serrated bottom edge 144 and a serrated top edge 145.

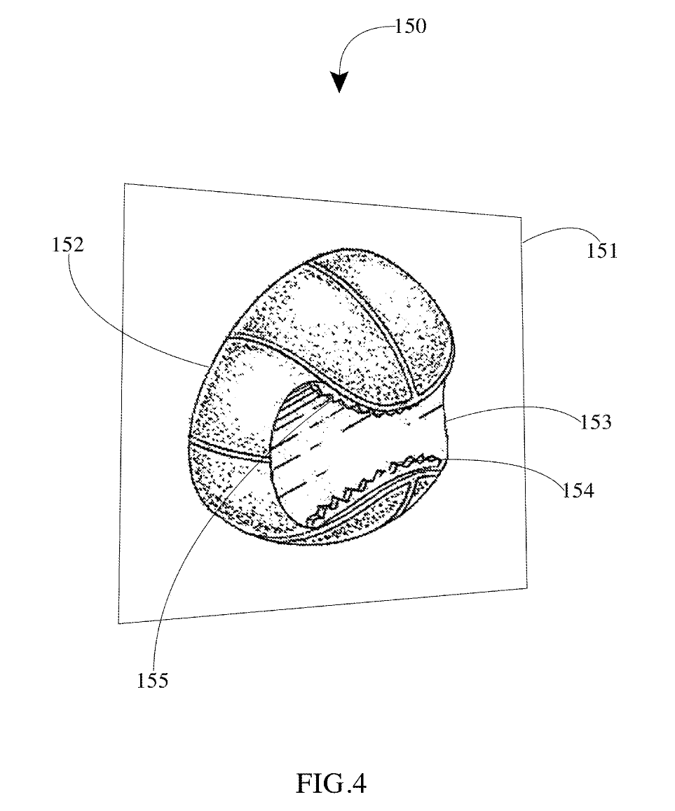

FIG. 4 shows the bottle opener 150 which is part of the bottle carrying and opening system 100 of FIG. 1, according to an embodiment of the present disclosure. As above, the bottle opener 150 may include a base panel 151 and a functional sports article 152. The functional sports article 152 may be shaped to represent a basketball and may include a mouth opening 153 configured to receive the lip 22 (FIG. 1) of the cap 21 (FIG. 1) of the bottle 20 (FIG. 1). The mouth opening 153 may include a serrated bottom edge 154 and a serrated top edge 155.

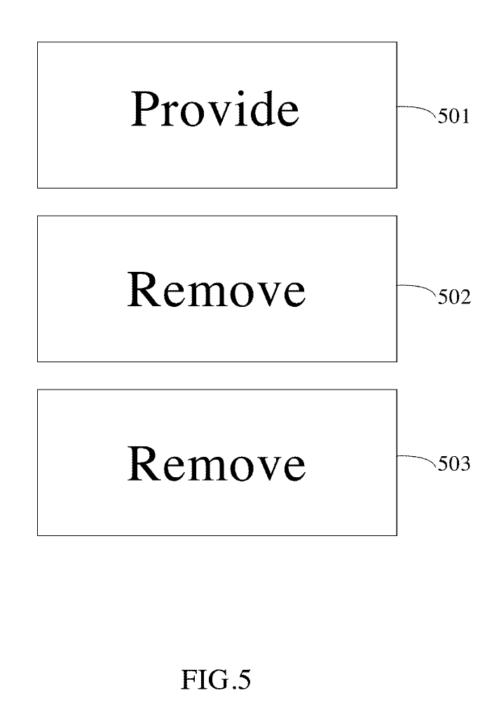

FIG. 5 is a flow diagram illustrating a method for carrying and opening bottles, according to an embodiment of the present disclosure. In particular, the method for carrying and opening bottles 500 may include one or more components or features of the bottle carrying and opening system 100 as described above. As illustrated, the method for carrying and opening bottles 500 may include the steps of: step one 501, providing a bottle carrying and opening system including a container and a bottle opener (as described above); step two 502, removing a bottle from the container; step three 503, removing a cap of the bottle using the bottle opener.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for carrying and opening bottles. Those with ordinary skill in the art will now appreciate that upon reading this specification and by their understanding the art of bottle cases as described herein, methods of installation, use, and structure will be understood by those knowledgeable in such art

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bottle carrying and opening system comprising:
a container having a bottom wall and a perimeter wall extending upwardly from said bottom wall, the container having an interior space configured to hold a plurality of bottles therein; and
a bottle opener coupled vertically and externally to the perimeter wall, said bottle opener configured to remove a cap of said bottle.

2. The bottle carrying and opening system of claim 1, wherein the bottle opener comprises
a base panel having a back surface and a front surface wherein the back surface is coupled to the perimeter wall; and
a functional sports article coupled vertically to the front surface of the base panel.

3. The bottle carrying and opening system of claim 2, wherein the functional sports article includes a flat back surface, a convexly arcuate front surface, and a mouth opening in the convexly arcuate front surface, said mouth opening configured to receive a lip of the cap of the bottle.

4. The bottle carrying and opening system of claim 3, wherein the convexly arcuate front surface is shaped to represent one of a baseball, football or basketball.

5. The bottle carrying and opening system of claim 3, wherein the mouth opening includes a serrated bottom edge and a serrated top edge.

6. The bottle carrying and opening system of claim 2, wherein the functional sports article is shaped to represent a hockey puck and includes a hole in a center of said hockey puck configured to receive a lip of the cap of the bottle.

7. The bottle carrying and opening system of claim 6, wherein the hole in the center of the hockey puck includes a serrated bottom edge and a serrated top edge.

8. The bottle carrying and opening system of claim 2, wherein the functional sports article is adhesively coupled vertically to the front surface of the base panel.

9. The bottle carrying and opening system of claim 2, wherein the back surface of the base panel is adhesively coupled to the perimeter wall.

10. The bottle carrying and opening system of claim 2, wherein the base panel and the functional sports article are made of plastic.

11. The bottle carrying and opening system of claim 2, wherein the base panel and the functional sports article are made of metal.

12. The bottle carrying and opening system of claim 2, wherein the base panel is 3.5 cm long and 3 cm wide.

13. The bottle carrying and opening system of claim 11, wherein the functional sports article is 1 cm thick.

14. The bottle carrying and opening system of claim 1, wherein the perimeter wall of the container further includes two opposing slits, said two opposing slits configured to receive four human fingers each.

15. The bottle carrying and opening system of claim 14, wherein the bottle opener is coupled to the perimeter wall beneath one of the two slits.

16. The bottle carrying and opening system of claim 1, wherein the container further comprises
a top wall removably coupled to the perimeter wall; and
a handle coupled to the top wall.

17. The bottle carrying and opening system of claim 1, wherein the container is made of fiber board.

18. A bottle carrying and opening system comprising:
a container having a bottom wall and a perimeter wall extending upwardly from said bottom wall, the container having an interior space configured to hold a plurality of bottles therein; and
a bottle opener vertically and externally coupled to the perimeter wall, said bottle opener configured to remove a cap of said bottle;
wherein the bottle opener comprises
a base panel having a back surface and a front surface, said back surface coupled to the perimeter wall; and
a functional sports article coupled to the front surface of the base panel;
wherein the functional sports article includes a flat back surface, a convexly arcuate front surface, and a mouth opening in the convexly arcuate front surface, said mouth opening configured to receive a lip of the cap of the bottle;
wherein the convexly arcuate front surface is shaped to represent one of a baseball, football or basketball;
wherein the mouth opening includes a serrated bottom edge and a serrated top edge;
wherein the functional sports article is adhesively coupled to the front surface of the base panel;
wherein the back surface of the base panel is adhesively coupled to the perimeter wall;
wherein the base panel and the functional sports article are made of plastic;
wherein the base panel is 3.5 cm long and 3 cm wide;
wherein the functional sports article is 1 cm thick;
wherein the perimeter wall of the container further includes two opposing slits, said two opposing slits configured to receive four human fingers each;
wherein the bottle opener is coupled to the perimeter wall beneath one of the two slits;
wherein the container further comprises
a top wall removably coupled to the perimeter wall; and
a handle coupled to the top wall; and
wherein the container is made of fiber board.

19. The bottle carrying and opening system of claim 18, further comprising set of instructions; and wherein the bottle carrying and opening system is arranged as a kit.

20. A method of carrying and opening bottles, the method comprising the steps of:
providing a bottle carrying and opening system, the bottle carrying and opening system including a container and a bottle opener, the container having a bottom wall and a perimeter wall extending upwardly from said bottom wall, the container having an interior space configured to hold a plurality of bottles therein, the bottle opener coupled to the perimeter wall, and the bottle opener configured to remove a cap of said bottle;
removing a bottle from the container; and
removing a cap of the bottle using the bottle opener.
